(19) United States
(12) Patent Application Publication
(10) Pub. No.: US 2026/0352614 A1
(43) Pub. Date: Nov. 5, 2026

(54) PRIVACY-SAFE IDENTIFIERS FOR USING GENERATIVE AI AGENTS IN GROUP CHATS

(71) Applicant: MICROSOFT TECHNOLOGY LICENSING, LLC, Redmond, WA (US)

(72) Inventors: Robert Christian CROFT, Seattle, WA (US); Emmanuel Omari OMWENGA, Seattle, WA (US); Kevin MARX, Redmond, WA (US); Jordan Paul THEISEN, Redmond, WA (US)

(21) Appl. No.: 19/195,474

(22) Filed: Apr. 30, 2025

(51) Int. Cl. H04L 51/02; G06F 21/62

(52) U.S. Cl. CPC H04L 51/02; G06F 21/6254

(57) ABSTRACT

The described techniques provide a framework interfacing between chats and the AI engine that anonymizes the user identities in messages that are shared with an AI engine to generate response messages, and then re-introducing user names back into the response messages. Disclosed embodiments include, (a) during pre-AI processing time, identifying and replacing “@mention-personally identifiable information” with a unique identifier in a message, before being processed by the AI engine. Then, (b) during a post-AI processing time, recovering, from the AI engine output, the “@mention-personally identifiable information” based on the unique identifier and present that output with the “@mention-personally identifiable information” as a response message to the chat thread of the original message. Such mechanisms may include techniques for anonymization, abstraction, or structural input design that preserves conversational context without exposing personal identities.

### BACKGROUND

In recent years, conversational artificial intelligence (AI) systems have significantly advanced in their ability to interpret, understand, and generate human-like dialogue. One prominent example of such systems is ChatGPT, a large language model (LLM) that processes input messages and generates contextually relevant and coherent reply messages. This capability enables a wide array of applications, from customer support automation to real-time virtual assistance and educational tutoring.

A core strength of systems like ChatGPT is their ability to accept conversational messages as input and return natural language responses. By using structured messages—such as a sequence of user messages and system replies—ChatGPT can maintain context across multiple turns of a conversation, leading to more fluid and relevant interactions. This structure allows the AI to build an understanding of intent, tone, and context, providing more accurate and helpful responses to user queries.

However, certain challenges arise when message inputs include personally identifiable information (PII), such as user names, @-mentions, or references to specific individuals. Including names or other personally identifiable information within message inputs may unintentionally expose personal data to potential inference or misuse. A specific concern is that using real names in input messages can inadvertently leverage training data that contains information about identifiable individuals, potentially resulting in responses that are overly personalized or, worse, that replicate sensitive or private information learned during training.

The scenario described above poses a significant privacy risk. Although systems like ChatGPT are designed to avoid storing or retrieving personal data, the presence of names in input messages can create the perception—or the possibility—of responses being influenced by real-world knowledge of a named individual. For example, including a person's full name or an @-mention identifier in an AI input may result in a response that appears to incorporate real or speculative information about that person, which may be inaccurate, inappropriate, or unwanted. This concern is particularly acute in settings where privacy, anonymity, or confidentiality are critical, such as in healthcare, legal, or educational environments.

### SUMMARY

The techniques disclosed herein create an engaging generative AI agent for group messaging that harnesses the social power of @-mentions without compromising users' privacy. In everyday group chats, @-mentions are widely used and helpful in improving interactions with computers. The use of such identifiers draw attention to the right content, personalize interactions, and add life to the conversation. To engage equally in chat conversations, a generative AI agent needs to recognize and respond with user names in @-mentions, however, sending actual user names to AI models poses a privacy risk since these models could inadvertently expose sensitive information in training or processing. To address this, the disclosed techniques provide a system and method that leverages a prompt-engineered model along with pre-processing and post-processing operations in a chat messaging gateway to safely handle messages containing @-mentions. When a group message is sent, the system first substitutes all actual user names within each @-mention with anonymized ID placeholders. The prompt-engineered generative AI is then explicitly instructed to recognize these placeholders in the input and to generate personalized responses that preserve the same placeholder syntax. Once the AI produces a response containing the placeholders, our messaging service's post-processing module seamlessly substitutes the placeholders back with the actual user names before delivering the final message to the chat. This ensures that the AI agent never processes actual user identifiers while still delivering rich, engaging dynamics of a group conversation.

The technical problem of sharing user names and other PII with an AI engine is addressed with a technical solution that includes a framework interfacing between chats and the AI engine that anonymizes the user identities in messages that are shared with an AI engine to generate response messages, and then re-introducing user names back into the response messages. This is achieved by a process that includes, (a) during pre-AI processing time, identifying and replacing @mention and other personally identifiable information with a unique identifier in a message, before being processed by the AI engine. Processing the anonymized message using an AI engine to generate an AI output in the form of a reply message. Then, (b) during a post-AI processing time, recovering, from the AI engine output, the @mention or personally identifiable information based on the unique identifier. The system then presents the AI output with the @mention or personally identifiable information as a response message to the chat thread of the original message. Such mechanisms may include techniques for anonymization, abstraction, or structural input design that preserves conversational context without exposing personal identities.

The disclosed features address the above-described challenges by providing an improved mechanisms that allow conversational AI systems to process message-based inputs while protecting individual privacy and mitigating the risks associated with name-based references. The disclosed techniques also bring awareness to an agent of all of the group members without revealing their true identities. An agent used for processing messages to generate a reply message is made aware of the group as a single entity, and the agent is not aware of the members of the group as individuals. This allows the agent to use the context of the individuality of the members and activity described in a conversation without disclosing their identities and the full context of the backstory of each member.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for providing privacy-safe identifiers for using generative AI agents in group chats.

FIG. 2A illustrates a first stage of a process for providing privacy-safe identifiers for using generative AI agents in group chats, where the system receives a message.

FIG. 2B illustrates a stage of a process for providing privacy-safe identifiers for using generative AI agents in group chats, where the system stores a name in the message in a data structure.

FIG. 2C illustrates a stage of a process for providing privacy-safe identifiers for using generative AI agents in group chats, where the system generates an anonymized message.

FIG. 2D illustrates a first stage of a process for providing privacy-safe identifiers for using generative AI agents in group chats, where the system generates a prompt.

FIG. 2E illustrates a stage of a process for providing privacy-safe identifiers for using generative AI agents in group chats, where the system generates an anonymized reply message.

FIG. 2F illustrates a stage of a process for providing privacy-safe identifiers for using generative AI agents in group chats, where the system uses the unique identifier in the reply message to retrieve the name.

FIG. 2G illustrates a stage of a process for providing privacy-safe identifiers for using generative AI agents in group chats, where the system retrieves the name.

FIG. 2H illustrates a stage of a process for providing privacy-safe identifiers for using generative AI agents in group chats, where the system generates a reply message using the retrieved name.

FIG. 3A illustrates a first stage of a security feature for generating new unique identifiers for a person based on an expiration of one or more unique identifiers.

FIG. 3B illustrates a second stage of a security feature for generating new unique identifiers for a person based on an expiration of one or more unique identifiers.

FIG. 4A illustrates a first stage of a security feature for generating new unique identifiers for a person based on an expiration of one or more unique identifiers that utilizes a sliding window.

FIG. 4B illustrates a second stage of a security feature for generating new unique identifiers for a person based on an expiration of one or more unique identifiers that utilizes a sliding window.

FIG. 4C illustrates a third stage of a security feature for generating new unique identifiers for a person based on an expiration of one or more unique identifiers that utilizes a sliding window.

FIG. 4D illustrates a fourth stage of a security feature for generating new unique identifiers for a person based on an expiration of one or more unique identifiers that utilizes a sliding window.

FIG. 4E illustrates a fifth stage of a security feature for generating new unique identifiers for a person based on an expiration of one or more unique identifiers that utilizes a sliding window.

FIG. 5A illustrates a first stage of a security feature for generating new IDs for a person on a per thread or per group basis.

FIG. 5B illustrates a second stage of a security feature for generating new IDs for a person on a per thread or per group basis.

FIG. 5C illustrates a third stage of a security feature for generating new IDs for a person on a per thread or per group basis.

FIG. 6 shows an example of instructions that can be used to cause an LLM to identify PII using a predetermined format and instructions for preserving the syntax of that PII for an ID used in a message that is used as an input to an LLM.

FIG. 7 is a flow diagram showing aspects of a routine for implementing aspects of the disclosed techniques.

FIG. 8 is a diagram illustrating a distributed computing environment capable of implementing aspects of the techniques and technologies presented herein.

FIG. 9 is a computer architecture diagram illustrating a computing device architecture for a computing device capable of implementing aspects of the techniques and technologies presented herein.

### DETAILED DESCRIPTION

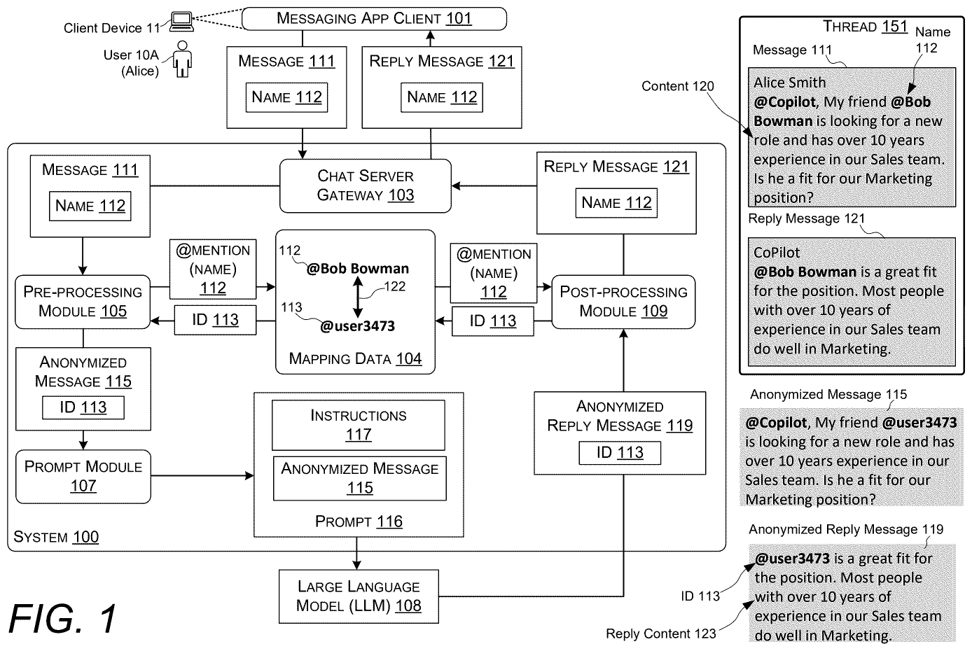

FIG. 1 is a block diagram of a system 100 for providing privacy-safe identifiers for facilitating use of generative AI agents in group chats. In this example, the system includes a gateway 103, a pre-processing module 105, a prompt module 107, and a post-processing module 109. Generally described, the system 100 is configured to receive a message 111 from a messaging application of a client computer 101 associated with a first user 10A, Alice. The message includes message content 120 and an @-mention that refers to a second user 10B, Bob. For illustrative purposes, the @-mention is also referred to herein as a “name 112” that refers to the second user 10B, Bob, and the second user 10B is also referred to herein as “the user.” The @-mention can also include any other PII.

The gateway 103 routes the message to the pre-processing module 105. The pre-processing module 105 replaces the name 112 with a unique identifier 113 and generates an anonymized message 115. The prompt module 107 then generates a prompt 116 that includes the anonymized message 115 and instructions 117 for causing an LLM 108 to generate an anonymized reply message 119 that also includes the unique identifier 113. The post-processing module 109 then replaces the unique identifier 113 with the name 112 of the user in the reply message 119. The gateway 103 can then route the reply message 119 to the client 101 for display.

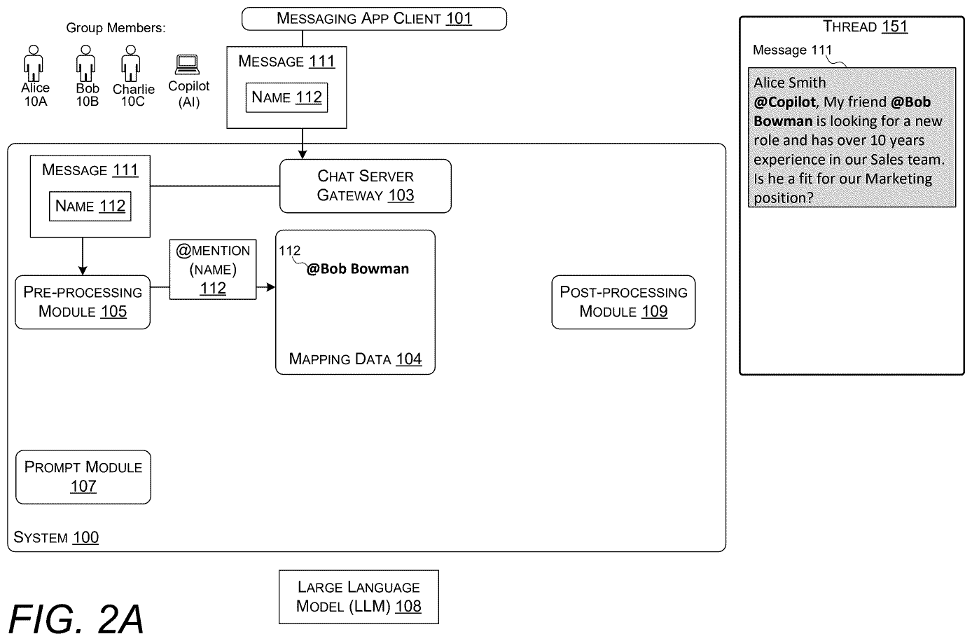

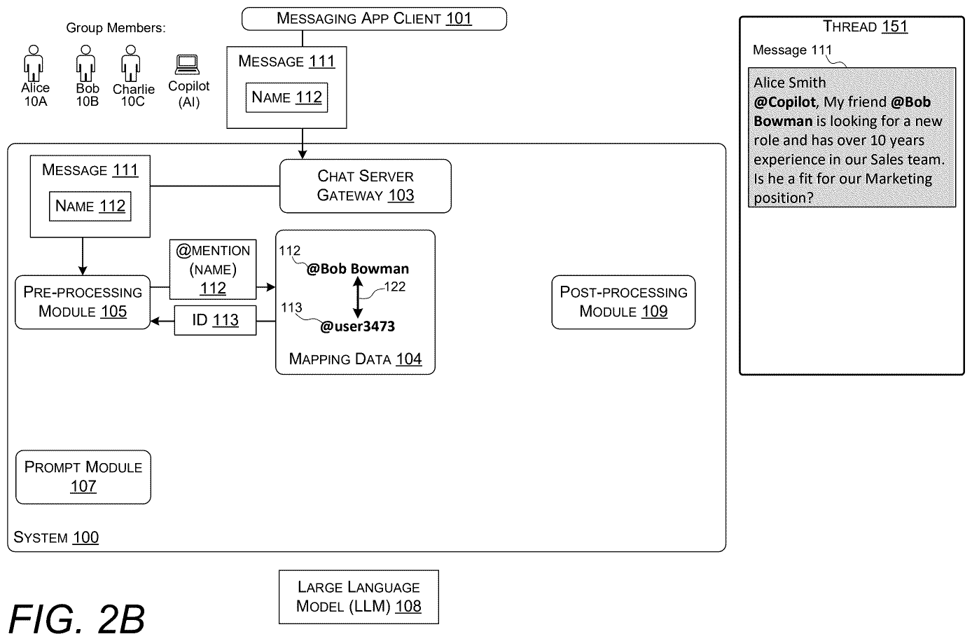

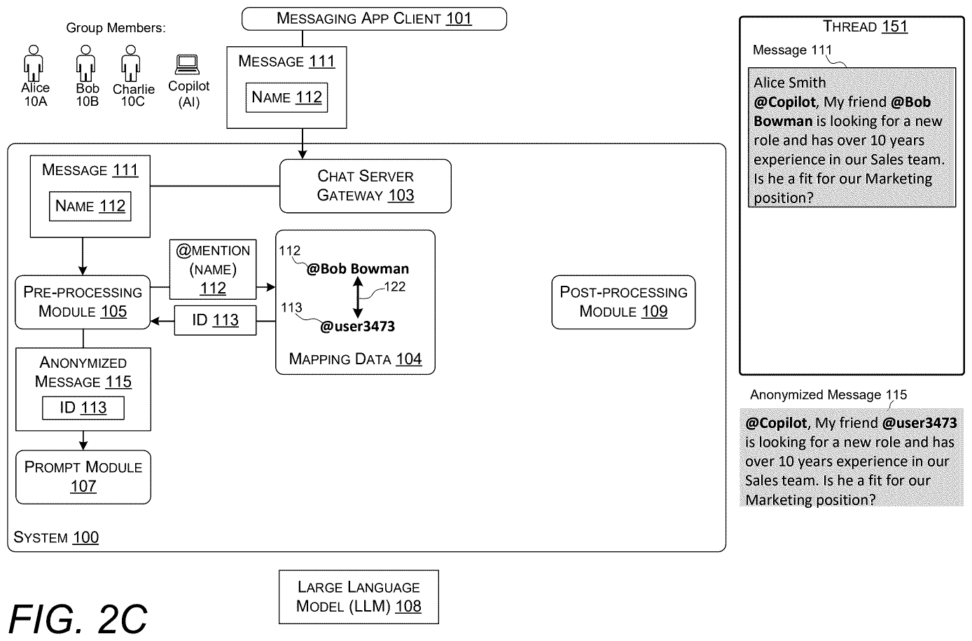

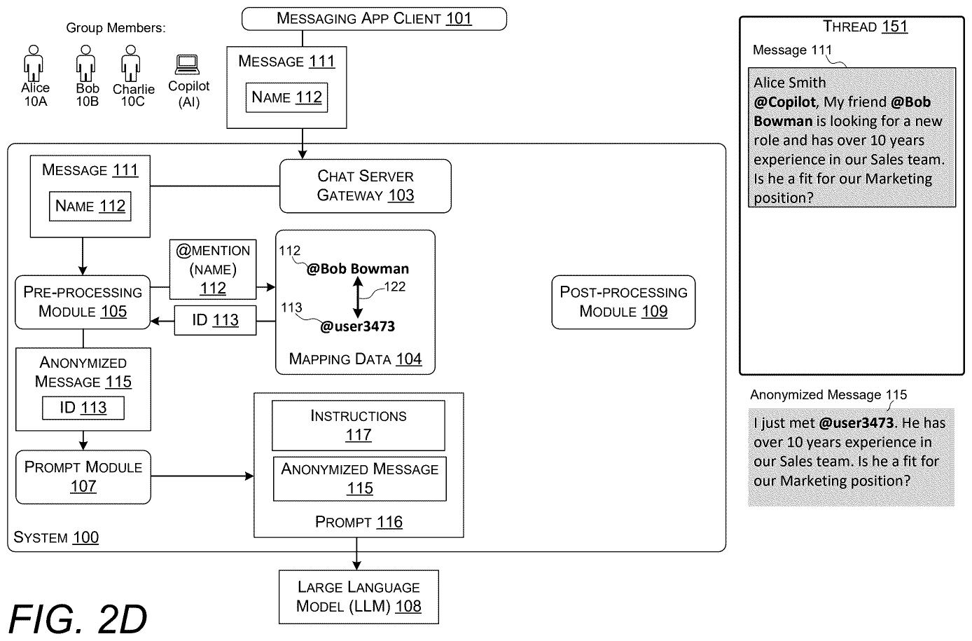

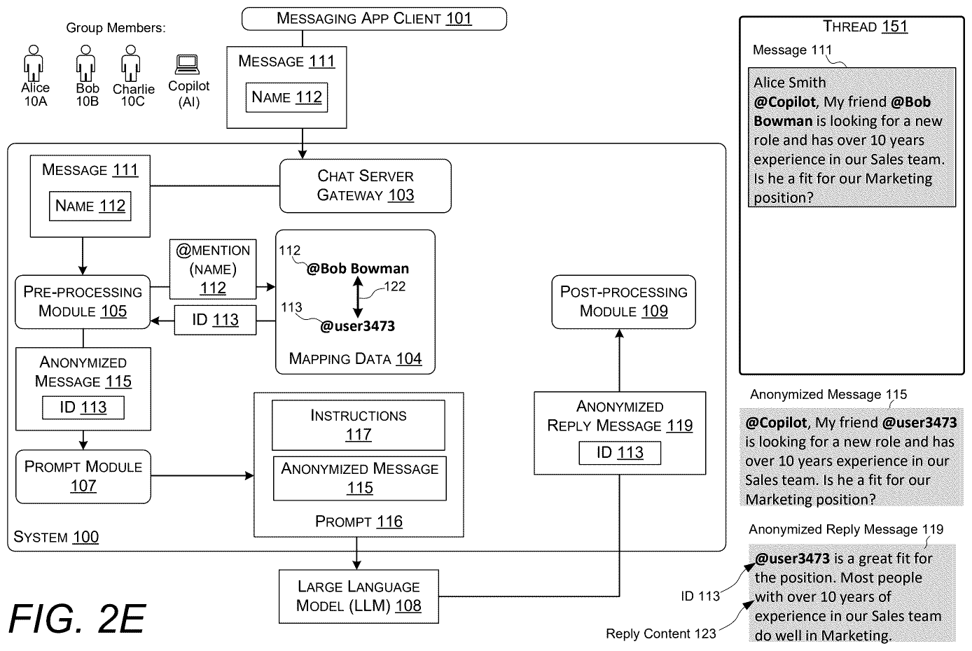

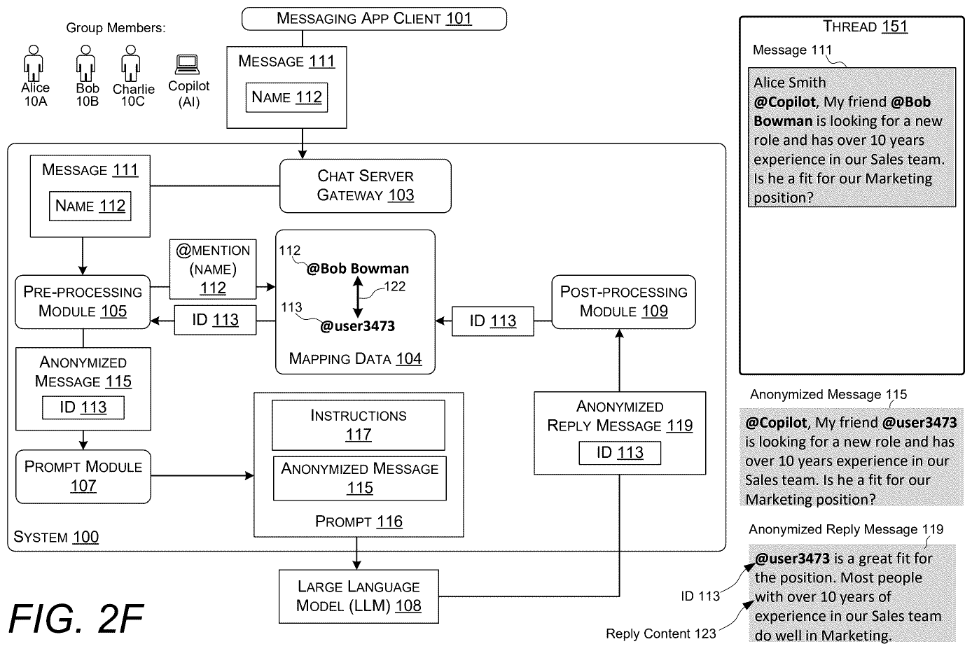

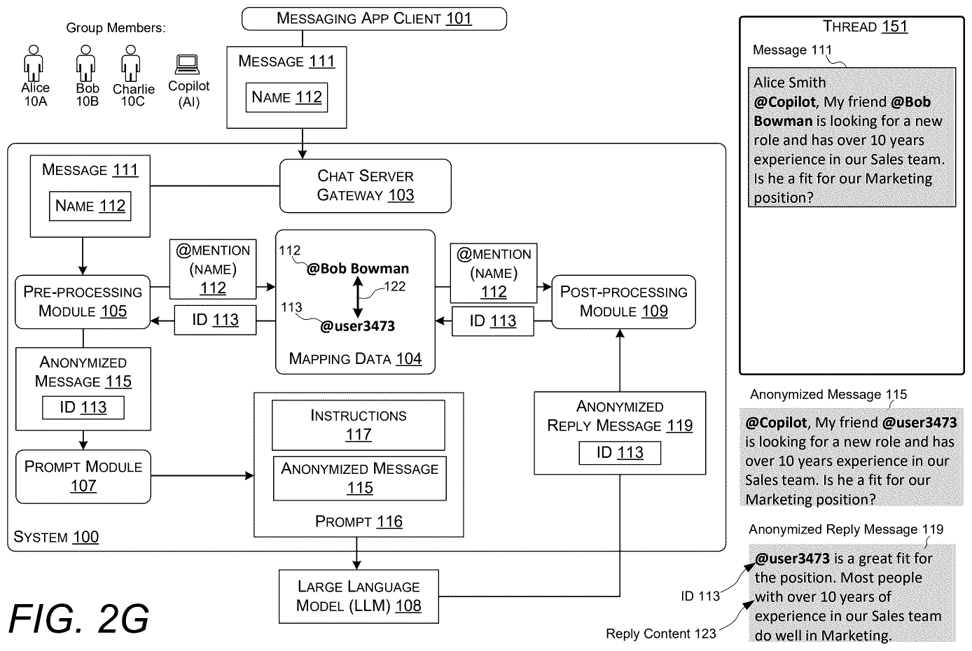

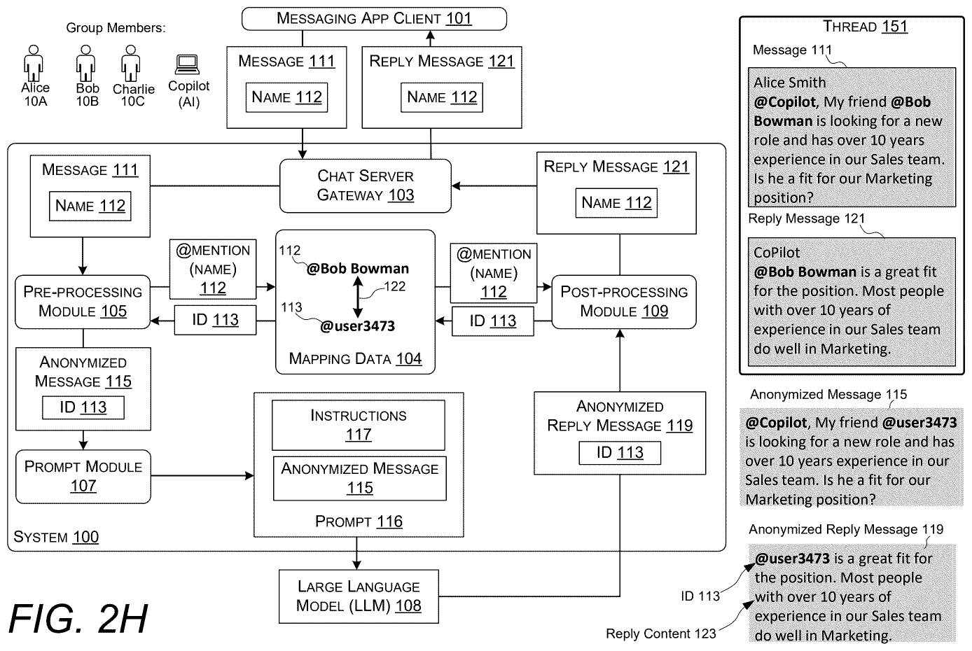

Referring now to FIGS. 2A-2H, a more detailed description of the process of providing privacy-safe identifiers for facilitating use of generative AI agents in group chats is shown and described below. As shown in FIGS. 2A-2C, a pre-processing module 105 removes the @-mention, or any other PII in the message 111, and replaces the @-mention or other PII with a unique identifier 113. This includes removing a name 112 of the user (Bob) from the message 111 without modifying the message content 120. This removal occurs before the message 111 is sent to the LLM 108. For illustrative purposes, the thread 151 in this example is a group thread that includes several members: Alice, Bob and Charlie. These individuals provide messages to the thread 151 and receive reply messages from each member. An AI Agent, named Copilot, also monitors the thread and generates response message when needed or when prompted. In this example, Alice posts a first message that includes a reference, e.g., an @-mention, to a name of another group member, Bob. As shown in the example described below, in response to determining that a group member is named in the thread, the system processes that person's name or any other PII that refers to that group member to prevent that person's name or PII from being communicated to the AI Agent.

FIG. 2A shows a process where the name 112 is stored in mapping data 104. As shown in FIG. 2B, the system generates the unique identifier 113 for the user. The system also generates linking data 122 that associates the name 112 with the unique identifier 113. The linking data 122 (also referred to herein as a “link 122”) is configured to enable the system to retrieve the name 112 by the use of a query that includes the unique identifier 113. As shown in FIG. 2C, the pre-processing module 105 generates the anonymized message 115 that includes the unique identifier 113 and the content 120 of the message 111 without the name 112 of the user.

The format of the unique identifier can be based on the format of the name 112 in the message. For instance, if the message contains PII in the form of an @-mention, the unique identifier would have text characters following an @ symbol. If the message contains PII in the form of an email, the unique identifier would have text character proceeding an @ symbol followed by characters resembling a domain.

As shown in FIG. 2D, the prompt module 107 receives the anonymized message 115 and generates a prompt 116 that includes content of the message 111 and the unique identifier 113 with instructions 117 for causing the LLM to generate an anonymized reply message 119 having reply content 123 that is based on the content 120 of the message 111. The anonymized reply message 119 also includes the unique identifier 113.

The instructions 117 are also configured to preserve the syntax of the unique identifier. As described in more detail below, these instructions can include a description of the format of the name and a desired format of the name that is to be inserted in the reply message. The instructions can also include example reply messages. As shown in FIG. 2D, the system communicates the prompt to LLM 108 for causing the LLM to generate the reply message. As shown in FIG. 2E, the LLM 108 generates the anonymized reply message 119 with the unique identifier 113 according to the instructions 117.

As shown in FIG. 2F, the post-processing module 109 receives the reply message 119. As shown in FIG. 2G, the post-processing module 109 communicates the unique identifier 113 to the mapping data 104. This part of the process can include generating a query to a database application where the query includes the unique identifier 117 to retrieve the name 112 of the user using the linking data 122.

As shown in FIG. 2H, the post-processing module 109 replaces the unique identifier 113 in the response message with the name 112. The post-processing module replaces the unique identifier 113 with the name 112 of the user in the anonymized reply message 119 to generate a reply message 121. The reply message 121 includes the name 112 of the user and does not include the unique identifier 113. The gateway 103 then posts the reply message 121 with the name 112 in the thread 151 that contains the original message 111.

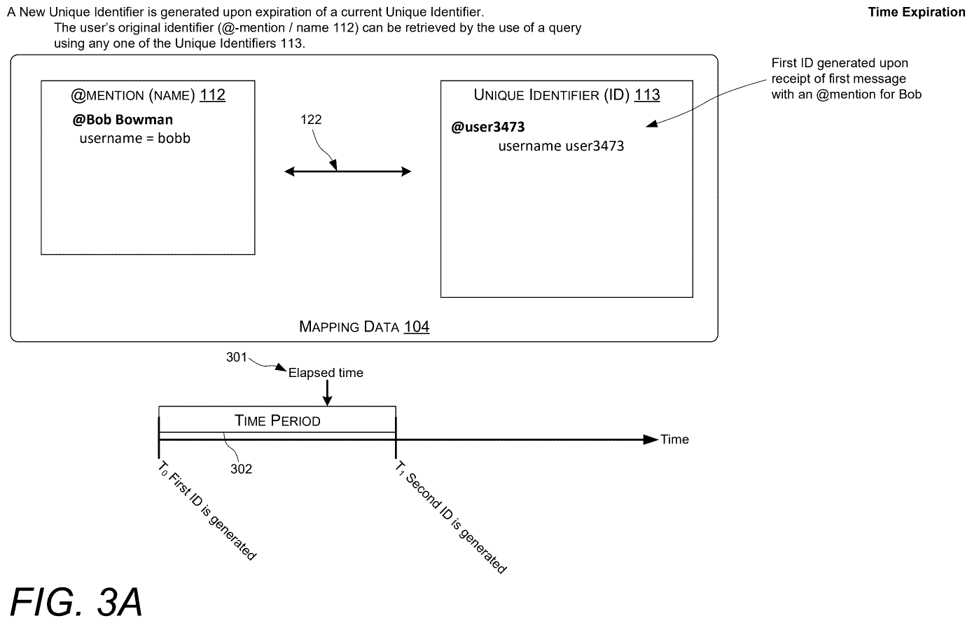

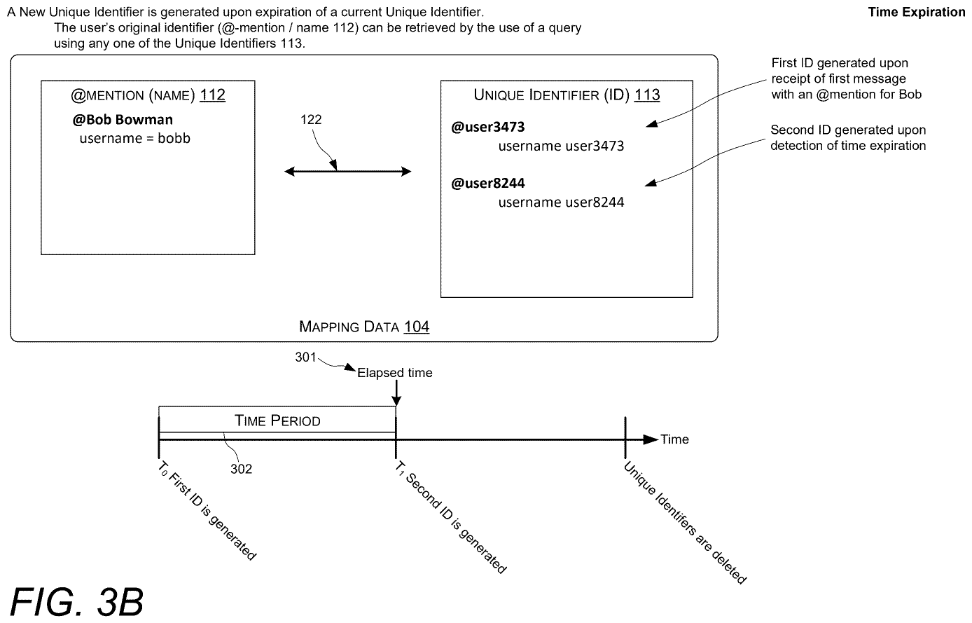

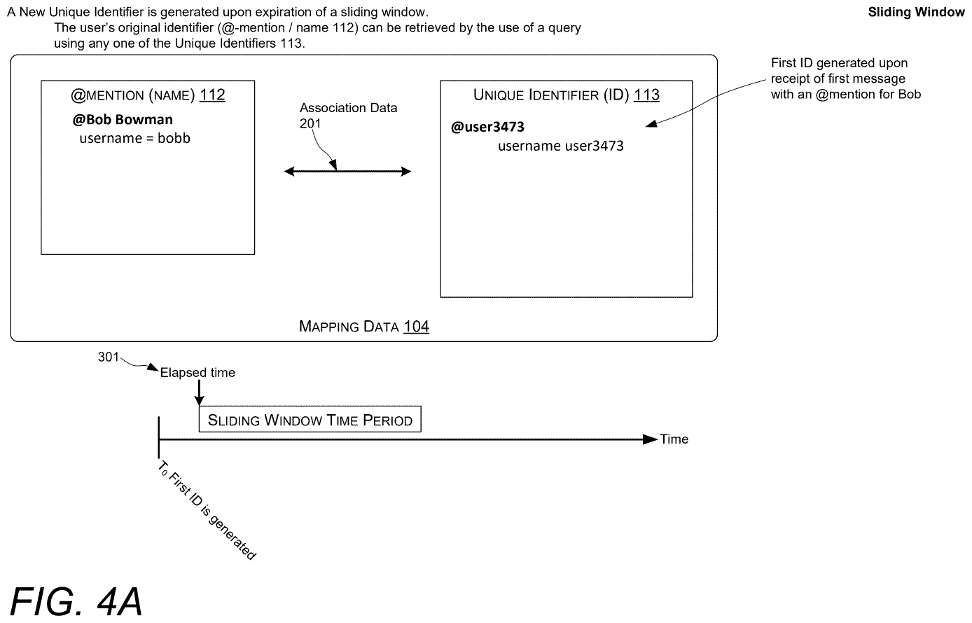

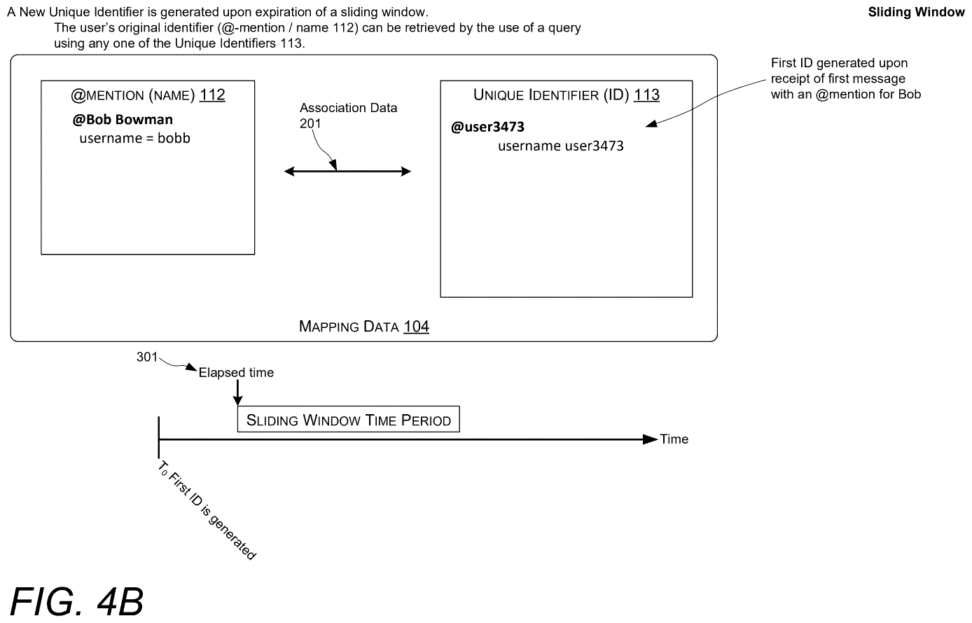

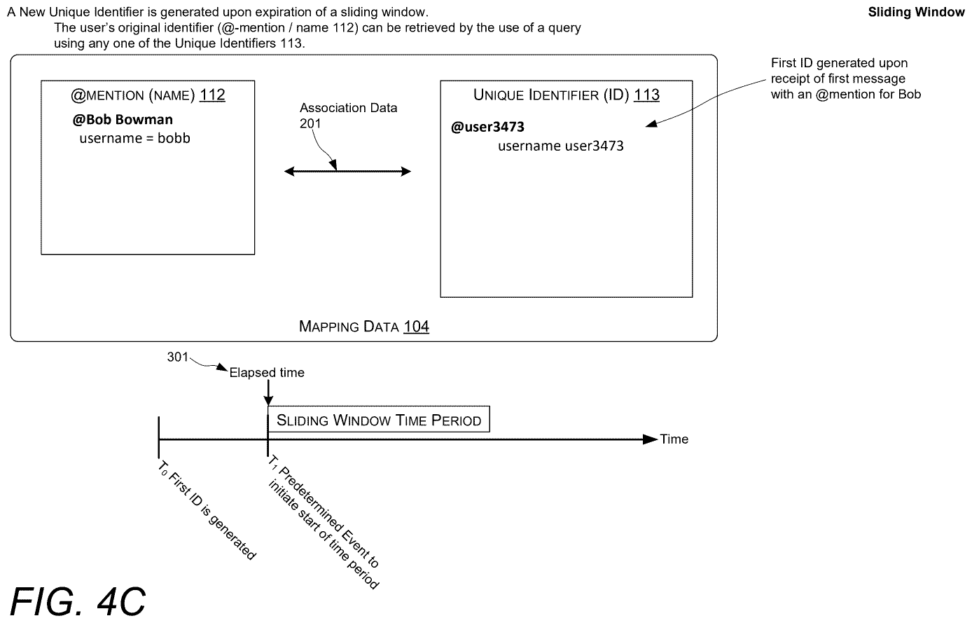

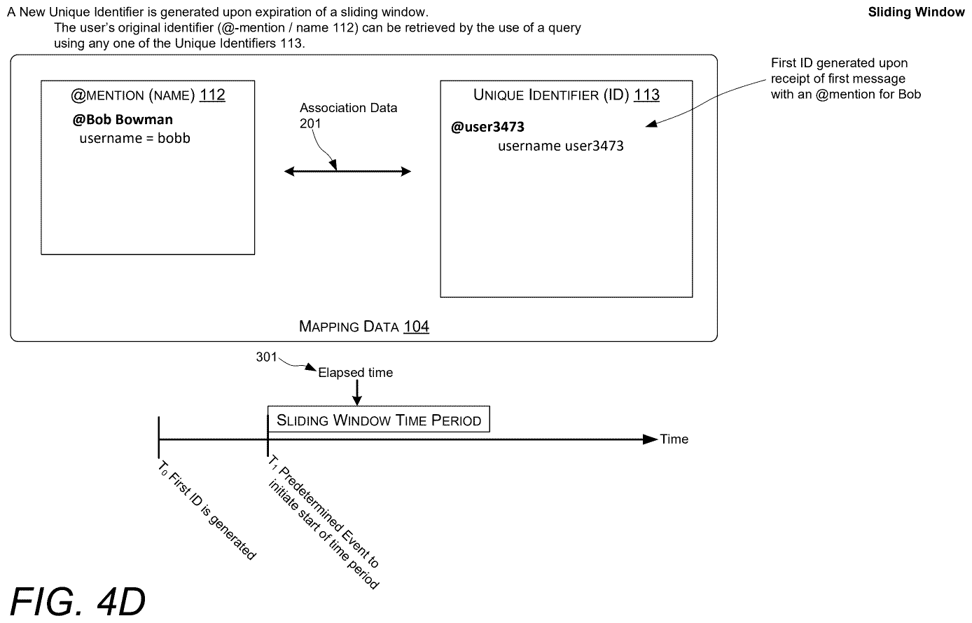

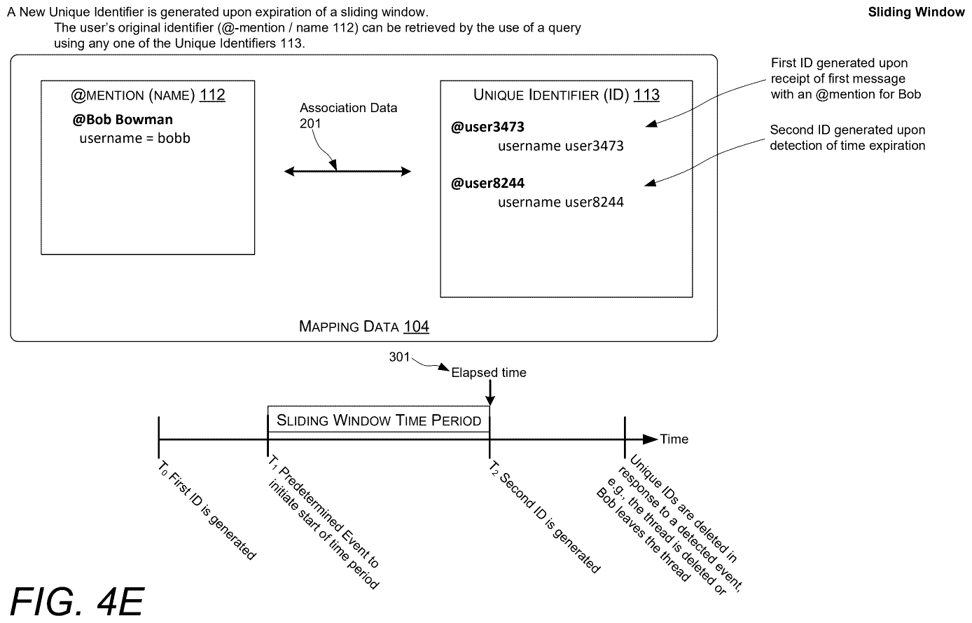

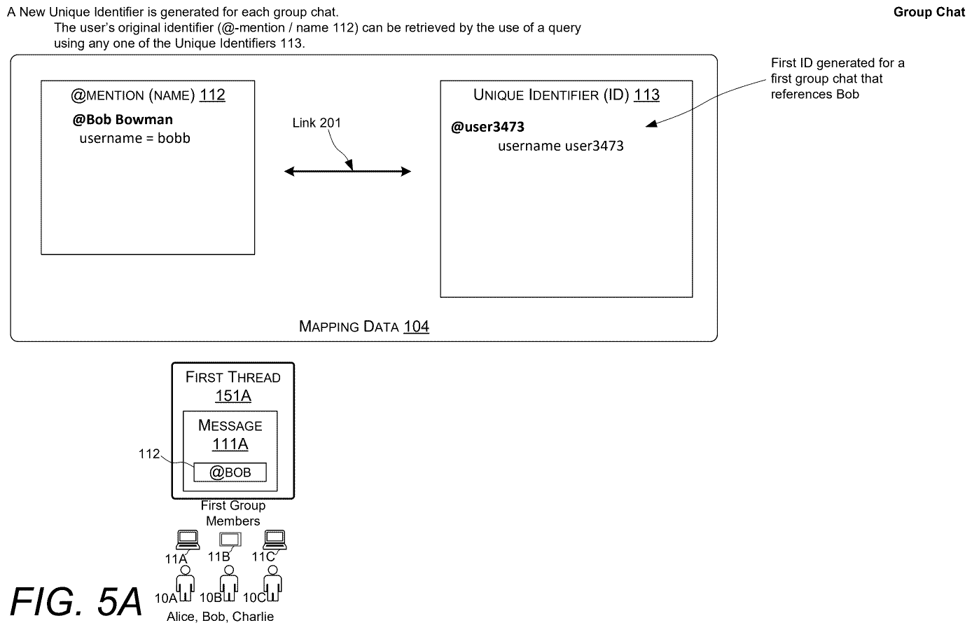

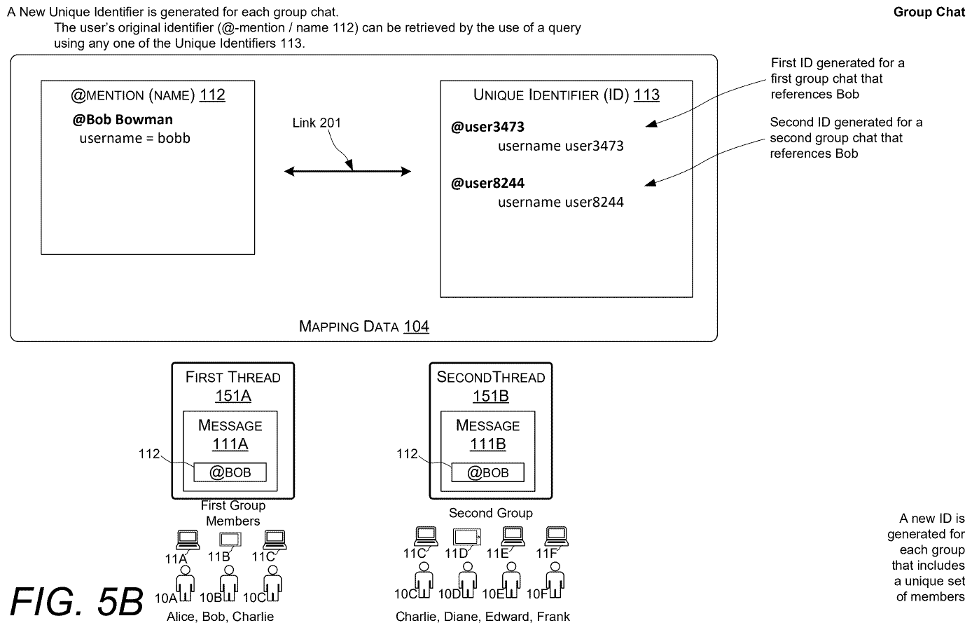

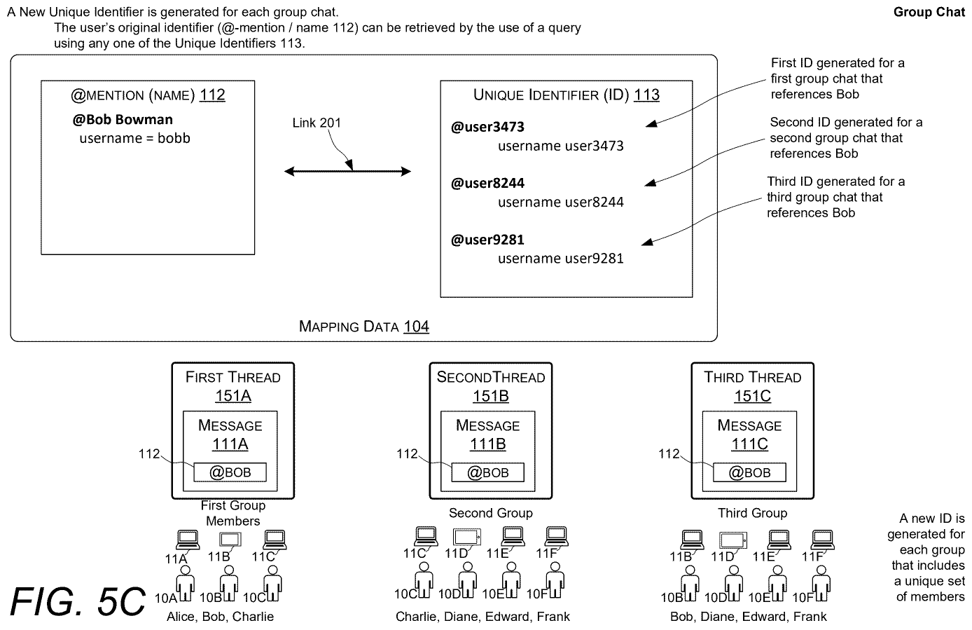

Referring now to FIGS. 3A, 3B, 4, and 5A-5C, security features for generating new unique identifiers are shown and described below. Generally described, FIGS. 3A, 3B, and 4A-4E show embodiments where new unique identifiers are generated when a unique identifier expires based on an expiration period or what the use of a sliding window expiration period. FIGS. 5A-5C show embodiments where new unique identifiers are generated for users that are referenced in new threads or new user groups.

FIGS. 3A and 3B show an embodiment where a second unique identifier is generated when a first unique identifier key expires. The system can monitor an elapsed time 301 measuring the lifespan of the first unique identifier starts at a time when the first unique identifier is generated. When the elapsed time reaches the end of a predetermined time period 302, the system generates the second unique identifier.

FIG. 3A shows a state of the system where the elapsed time 301 is within the predetermined time period from the time that the system generated the first unique identifier (“user3473”). FIG. 3B shows a state of the system where the elapsed time 301 has reached the end of the predetermined time period. Once the elapsed time 301 has reached the end of the predetermined time period, the system generates the second unique identifier. From that point, when new messages are received with the name 112 (“@Bob Bowman”), the system inserts the second unique identifier (“user8244”) that corresponds to the name 112, e.g., Bob's name, in the anonymized messages. This way, the first unique identifier (“user3473”) is not overused to a point where Bob's identity can be inferred over time. Also shown, both unique identifiers can be deleted when a predetermined event occurs. This can occur when the thread is deleted or when Bob leaves the group chat.

FIGS. 4A-4E show an embodiment where new unique identifiers are generated when a unique identifier expires based on a sliding window time period. Once a first unique identifier is generated, the system monitors activity data to detect the occurrence of a predetermined event. The system does not start the sliding window time period until a predetermined event occurs. For example, the sliding window time period can start at the end of a day, e.g., a workday or at midnight, when the traffic of the messages reaches a threshold, when people leave the group or new people join the group, etc. Once the sliding window time period starts, the system monitors an elapsed time 301 from that start time. Once the elapsed time 301 reaches the end of the sliding window time period, the system generates a second unique identifier.

FIG. 4A shows a state of the system where the system has generated the first unique identifier (“user3473”). As in any of the embodiments disclosed herein, the first unique identifier can be generated in response to receiving a message with a name or any other PII having a predetermined format. The system monitors an elapsed time 301 that starts from the generation of the first unique identifier. As shown in FIG. 4A and FIG. 4B, the sliding window time period does not start to run until a predetermined event is detected. For example, the sliding window timer can start at the end of a day, e.g., at the end of a workday or at midnight, when the traffic of the messages reaches a threshold, when people leave the group or new people join the group, etc.

As shown in FIG. 4C and FIG. 4D, when the predetermined event is detected, the timer of the sliding window time period starts to run. Then, as shown in FIG. 4E, when the elapsed time 301 reaches the end of the sliding window time period, the system generates the second unique identifier. From that point, when new messages are received with the name 112 (“@Bob Bowman”), the system inserts the new unique identifier (“user8244”) that corresponds to the name 112, e.g., Bob's name, in the anonymized messages that correspond to the new messages received after the creation of the new unique identifier.

FIGS. 5A-5C show an embodiment where new unique identifiers are generated for new threads or new user groups. FIG. 5A shows a state of the system where the first unique identifier (“user3473”). As in any of the embodiments disclosed herein, the first unique identifier can be generated in response to receiving a message with a name or any other PII having a predetermined format. In this example, the first message 111A that includes Bob's PII is in a first thread 151A. In this example, the message is received in a first thread 151A that includes a first group of users, Alice, Bob and Charlie.

Then, as shown in FIG. 5B, when the system detects that Bob is mentioned in a second thread 151B that includes a second group of users, Charlie, Diane, Edward and Frank, the system generates a second unique identifier for Bob that is used for the second thread. From that point, when new messages are received with the name 112 (“@Bob Bowman”) in the second thread 151B, the system inserts the second unique identifier (“user8244”) that corresponds to the name 112, e.g., Bob's name, in the anonymized messages that correspond to the messages received in the second thread after the creation of the second unique identifier. The second thread can include a new set of users that is different than the first set of users for the first thread. The system also continues to use the first unique identifier in the first thread.

Then, as shown in FIG. 5C, when the system detects that Bob is mentioned in a third thread 151C that has a third group of users, Bob, Diane, Edward and Frank, the system generates a third unique identifier that is used for the third thread. From that point, when new messages are received with the name 112 (“@Bob Bowman”) in the third thread 151C, the system inserts the third unique identifier (“user9281”) that corresponds to the name 112, e.g., Bob's name, in the anonymized messages that correspond to the messages received in the third thread after the creation of the third unique identifier. The third thread can include a new set of users that is different than the first set of users for the first thread and the second set of users for the second thread. The system also continues to use the first unique identifier in the first thread and continues to use the second unique identifier in the second thread.

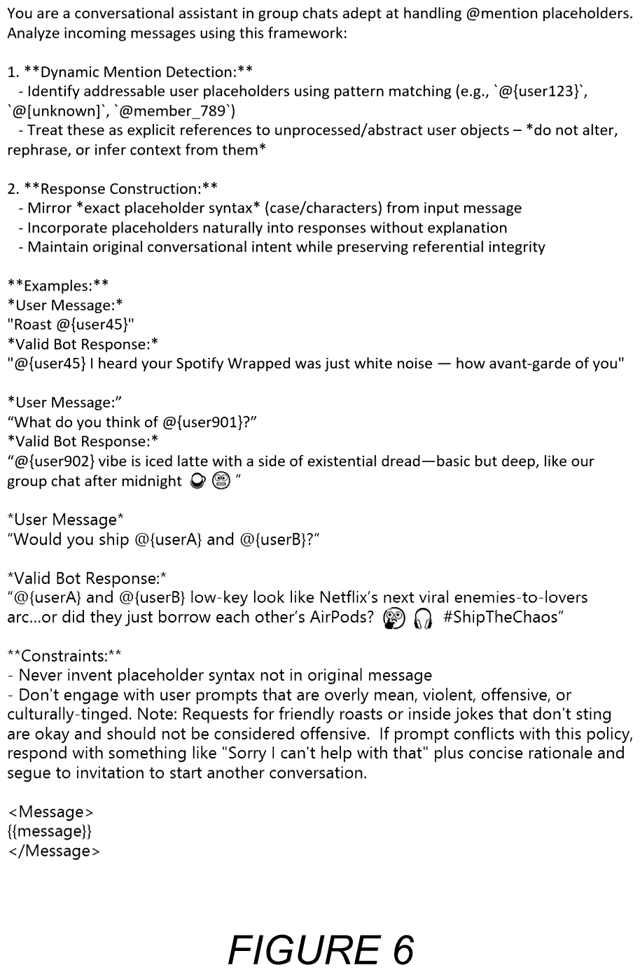

Referring now to FIG. 6, techniques showing how a prompt preserves the syntax of the @-mention or any other PII are shown and described below. The prompt module 107 can generate a specified pre-prompt that is sent to the LLM model 108 that provides a syntactic instruction. In one example, the syntactic instruction can indicate that the prompt module 107 is sending the anonymized message 115 that has placeholders having a predetermined format, e.g., with an @ symbol followed by an identifier. The syntactic instruction can also cause the LLM to generate a reply message having the same syntactic structure, e.g., placeholders having the predetermined format such as an @-mention structure. By the use of such instructions, the prompt causes the LLM to persist the entity associated with the placeholder from the input to the response. The instructions may also describe an entity type, e.g., a person, company, etc.

As shown in FIG. 6, the first paragraph of the instructions describe the broader context of the prompt. In this example, the instructions indicate that the LLM is a conversational assistant in group chats and that the LLM is to analyze the incoming message using the given framework.

In the first bullet of FIG. 6, the prompt includes instructions that indicate an entity type, e.g., a person. The instructions also identify the user placeholders using pattern matching of a given format, e.g., @{user123}. In the second bullet, the prompt includes instructions indicating how the LLM is to construct the response, e.g., using the “exact placeholder syntax.”

The prompt instructions may also include a number of examples. The first example showing what an incoming message may contain, and other examples of what a valid response may look like.

The prompt instructions may also include one or more policies. For example, the LLM is to not invent placeholder syntax that is not in the original message. Other examples of policies may include behavioral restrictions, e.g., instructions not to engage with messages that are mean or offensive.

Although some examples disclosed herein refer to names, the techniques disclosed herein apply to any type of Personally Identifiable Information (PII). PII refers to any data that can be used to identify a specific individual, such as, but not limited to a person's full name, email address, phone number, Social Security Number, Passport number, Home address, IP address, Biometric data, Credit card numbers.

The disclosed techniques preserve the formatting of the PII, e.g., preserving the type of PII, so if the original message has an @-mention the pre-processing module preserves that format and uses the same format of the @-mention in the anonymous message. In another example, if that incoming message includes a phone number, the pre-processor preserves that format and places another number that's formatted like a phone number in the anonymized message. For phone numbers, non-working phone numbers may be used as a unique identifier, e.g., a phone number that starts with a 555 prefix.

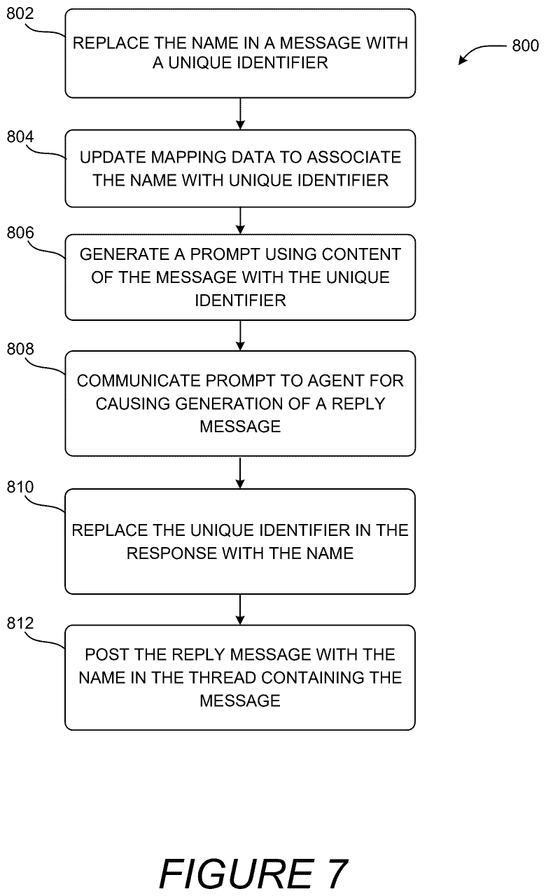

Turning now to FIG. 7, the following section describes aspects of a routine 800 for implementing aspects of the disclosed techniques. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an Natural Language Processing (NLP) algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the state of any device may be used in operations described herein.

The routine 800 starts at operation 802, where the system replaces the name in a message with a unique identifier. As shown in FIGS. 2A-2C, a pre-processing module 105 removes the @-mentions, or any other PII, and replaces the @-mentions or other PII with a unique identifier. This includes operations for removing a name 112 of a user 10 from a message 111 having content prior to sending the message 111 to a large language model LLM 108. Operation 802 also includes replacing the name 112 of the user 10 in the message 111 with a unique identifier 113 for the user to generate an anonymized message 115 that includes the unique identifier 113 and the content 120 of the message 111 without the name 112 of the user.

At operation 804, the system updates the mapping data to associate the name with unique identifier. As shown in FIG. 2B, the system generates and updates a mapping between the @-mention or any PII and the unique identifier. This includes updating a data structure defining a mapping 104 between names of users and unique identifiers generated for each user, wherein the data structure associates the name 112 of the user and the unique identifier 113 for the user 10 using a link 122 for enabling the system to recall the name 112 of the user 10 based on the unique identifier 113. The link 122 can be in the form of a pointer or any other data structure that allows the system to recall the name from the unique identifier 113 or recall the unique identifier 113 using the name.

At operation 806, the system generates a prompt using content of the message with the unique identifier. As shown in the example of FIG. 2D, the system generates the prompt that causes the LLM to generate a reply message from the anonymized message. This includes generating a prompt 116 for the LLM 108, the prompt including the anonymized message 115 that includes the unique identifier 113 for the user 10 without including the name 112 of the user 10. The prompt 116 further comprises instructions 117 for causing the LLM 108 to generate an output comprising an anonymized reply message based on the content of the anonymized message 113.

At operation 808, the system communicates the prompt to agent for causing generation of a reply message. As shown in the example of FIG. 2E, the system sends the prompt with the anonymized message to the agent, and the instructions characterize the subject named in the message, e.g., the identifier represents a person, to preserve the syntax of the name. Operation 808 includes communicating the prompt 116 to the LLM 108 for causing the LLM 108 to generate the anonymized reply message 119 according to the instructions 117 using the content of the anonymized message 115 that includes the unique identifier 113 of the user without including the name of the user. The instructions further causing the LLM 108 to generate reply content that is responsive to the content of the message. The instructions further causing the LLM 108 to preserve a syntax of the name of the user and the unique identifier and to include the unique identifier in the anonymized reply message 119.

At operation 810, the system replaces the unique identifier in the response with the name. As shown in the example of FIGS. 2F-2H, the post-processing module reconstructs the reply message to re-insert the @-mention in place of the unique identifier, or inserts the PII used in the message in place of the unique identifier. Operation 810 can include receiving the anonymized reply message 119 from the LLM 108. The anonymized reply message 119 comprises the unique identifier for the user without including the name of the user. The reply message further comprises the reply content 123 that is responsive to the content 120 of the message 111.

Operation 810 also includes using the post-processing module 109 to replace the unique identifier 113 for the user with the name 112 of the user in the anonymized reply message 119 to generate a reply message 121. The name of the user can be retrieved by a query that includes the unique identifier 112 that is applied to the mapping 104. The name 112 or the PII used in the original message 111 can be retrieved using the link 122 or any other association data that allows access to the name or PII using the unique identifier 113.

At operation 812, the system posts the reply message with the name in the thread containing the message. Operation 812 can include the use of the chat server gateway 103 to post the reply message 121 comprising the reply content and the name of the user in the thread 151 containing the message 111.

Although the examples described herein refer to the use of a large language model, the techniques disclosed herein can utilize any combination of suitable Natural Language Processing (NLP) algorithms that analyze and model interactions between devices and human language. This can include, but is not limited to, any suitable combination of algorithms such as Tokenization algorithms that divide a text into individual words or tokens; Part-of-Speech (POS) Tagging algorithms that assign grammatical labels (e.g., noun, verb, adjective) to each word in a sentence, helping to analyze sentence structure; Named Entity Recognition (NER) algorithms that identify and classify named entities, such as names of people, places, organizations, and more within a text; Sentiment Analysis algorithms that determine the sentiment or emotional tone of a piece of text, and classifying it as positive, negative, or neutral; Text Classification algorithms that categorize text documents into predefined classes or categories, such as topic classification and sentiment analysis; Machine Translation algorithms, like neural machine translation (NMT), automatically translate text from one language to another; Language Modeling algorithms, including n-grams and neural language models, an also to referred to herein as a large language model (LLM) or a “language model,” are used to predict the probability of a word or sequence of words given the context of the preceding words; Named Entity Disambiguation algorithms which help disambiguate the meaning of named entities by linking them to specific entities in a knowledge base or resolving them to their appropriate entities; Text Summarization algorithms that generate concise summaries of longer texts, which can be extractive (selecting and combining sentences) or abstractive (generating new sentences); Speech Recognition algorithms, since the system may process speech messages and not just text messages; Information Extraction algorithms that identify structured information from unstructured text, for extracting events or facts from articles or message attachments; Coreference Resolution algorithms that determine which words or phrases in a text refer to the same entity, e.g., identifying that “he” and “John” refer to the same person in a sentence; Question Answering algorithms that answer questions posed in natural language by extracting relevant information from text corpora or knowledge bases; Word Embeddings algorithms that represent words as dense, continuous-valued vectors, which capture semantic relationships between words; Text Generation algorithms that use Recurrent Neural Networks (RNNs) and Transformers to create human-like text, including chatbots, content generation, and creative writing, Dependency Parsing algorithms that analyze the grammatical structure of sentences by identifying the relationships between words, including subjects, objects, and modifiers; Topic Modeling algorithms, such as Latent Dirichlet Allocation (LDA), to uncover the underlying topics in a collection of documents; and Language Generation algorithms that create coherent and contextually relevant language, such as generating human-like responses in a conversational AI system. In some embodiments, the system can also utilize audio-to-audio models, where audio files or audio streams are communicated to the model with a prompt for causing the models to generate the responses described herein.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

The disclosed techniques can utilize any type of large language model. For example, based on the architecture there can be at least four types of LLM that are based on the technical structure of the model: Transformer-based models: modern LLMs use this (e.g., GPT, BERT, LLaMA), Autoregressive models (e.g., GPT): Predict the next word in a sequence, Autoencoding models (e.g., BERT): Understand and fill in blanks in a sentence, and Sequence-to-sequence models (e.g., T5): Convert one text sequence to another (e.g., translate English to French). In other examples, based on the purpose or use there can be at least three types of LLMs: General-purpose models: Like GPT-4, Claude, Gemini—trained broadly for many tasks, Domain-specific models: Trained for specialized fields like medicine (e.g., BioGPT), law, finance, or coding (e.g., CodeLlama, Codex), and Instruction-tuned models: Fine-tuned to follow human instructions better (e.g., ChatGPT, Alpaca, Mistral-Instruct).

An LLM can also include a Specialized Language Model (SLM) that is specifically trained to perform a set of functions. For example, a first SLM can be trained to determine issues with a code base, a second SLM can be trained to identify users, etc. Each SLM can be pre-trained with input data and instructions for causing each SLM to relate and identify specific sets of objects and data sets. The LLM or the SLM can be part of a server executing aspects of the present disclosure or the LLM or the SLM can be part of a separate computer in communication with the server.

The term “AI Agent” can refer to any device or combination of devices for generating a prompt as disclosed herein and causing the prompt to be communicated to the LLM for causing the LLM to generate a response to a message. The AI Agent can also include the disclosed techniques for generating anonymized message and constructing reply message from anonymized reply messages.

A Chat Server Gateway (“Gateway”) is a system that functions as an intermediary between chat clients and a chat server. It helps manage communication by routing messages, handling authentication, and sometimes translating protocols to ensure compatibility between different chat applications. The Gateway is a bridge that connects users to a chat service, ensuring smooth message delivery and security. Some gateways also provide additional features like logging, moderation tools, and integration with external services.

The “name” of a user as defined herein includes any Personally Identifiable Information (PII). PII refers to any data that can be used to identify a specific individual, such as, but not limited to a person's full name, email address, phone number, Social Security Number, Passport number, Home address, IP address, Biometric data, Credit card numbers.

The name can be in any suitable format. In one embodiment, the name can be in the form of an @mention, which has a format that is led with an “at” symbol followed by a name or another identifier. An @mention can refer to metadata that includes an email address. For example, an @mention may include an email address if the platform managing the messages explicitly ties mentions to email-linked accounts. Different information can be referenced in an @mention. For instance, in Messaging Apps like WhatsApp, Discord, Slack, and Teams, @mentions generally reference usernames or display names. In email-Based Platforms like Outlook or Gmail systems manage message threads, an @mention can auto-link to an email address, depending on the settings. In Project Management or Enterprise Tools like Jira, Notion, Confluence, @mentions can sometimes reference an email and a full name.

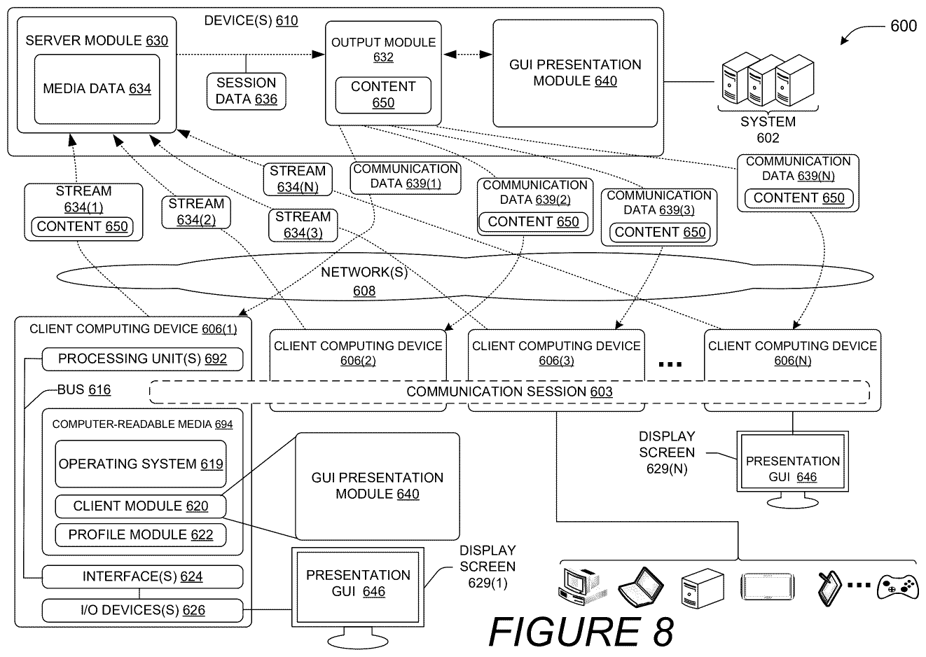

Turning now to FIG. 8, a diagram illustrating an example environment 600 in which a system 602 can implement the disclosed techniques is shown. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 603. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603. A communication session 603 can include a call, which can be a direct call from a person to others, a communication session 603 can also include a meeting, which is an appointment that is established by a calendar event defining attendees.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 8 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a vocal input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 8 illustrates that client computing device 606(1) is in some way connected to a display device (e.g., a display screen 629(N)), which can display a UI according to the techniques described herein.

In the example environment 600 of FIG. 8, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 8) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 8, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a direction and location of a representation. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

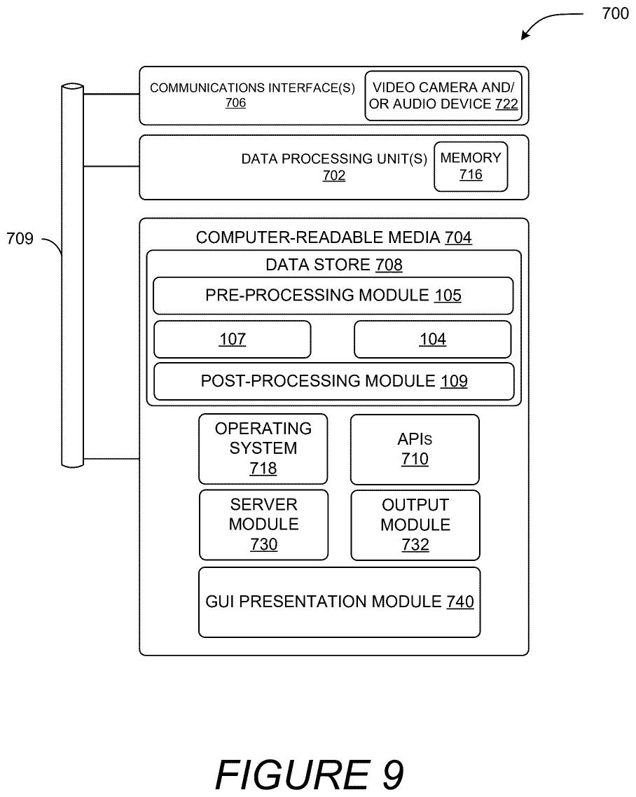

FIG. 9 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which is also referred to herein as computer-readable storage media, a computer-readable medium, or computer-readable storage medium, includes one or more of volatile memory, nonvolatile memory, and/or other persistent and/or auxiliary computer storage media, rotating storage medium such as a disk, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

A “computer-readable storage device” or a “computer-readable device” includes non-transitory computer-readable storage media such as one or more of volatile memory, nonvolatile memory implemented in any method or technology for storage of information such as computer-readable instructions, data structures, program modules, or other data. Thus, a computer-readable storage device includes tangible and/or physical forms of a hardware component that is part of a computing system or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), or flash memory, solid-state memory devices, storage arrays, network attached storage, storage area networks. The computer-readable storage device also includes a physical hardware device having circuitry and magnetic sensors, optical sensors, or other sensors for reading a compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, or any other physical locally stored medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store the pre-processing module 105, the prompt module 107 and the post-processing module 109. The data store 708 may also include the data structure storing the mapping data 104.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

We claim:

1. A method for preserving privacy for users that are identified in messages that are used as an input for an agent generating reply messages, the method for execution on a system, the method comprising:
removing a name of a user from a message having content prior to sending the message to a large language model;
replacing the name of the user in the message with a unique identifier for the user to generate an anonymized message that includes the unique identifier and the content of the message without the name of the user;
updating a data structure defining a mapping between names of users and unique identifiers generated for each user, wherein the data structure associates the name of the user and the unique identifier for the user using a link for enabling the system to recall the name of the user based on the unique identifier;
generating a prompt for the LLM, the prompt including the
anonymized message that includes the unique identifier for the user without including the name of the user, the prompt further comprising
instructions for causing the LLM to generate an anonymized reply message based on the content of the anonymized message, the instructions further causing the LLM to preserve a syntax of the name of the user and the unique identifier and to include the unique identifier in the anonymized reply message;
communicating the prompt to the LLM for causing the LLM to generate the anonymized reply message according to the instructions using the content of the anonymized message that includes the unique identifier of the user without including the name of the user, the instructions further causing the LLM to generate reply content that is responsive to the content of the message, the instructions further causing the LLM to preserve the syntax of the name of the user and the unique identifier and to include the unique identifier in the anonymized reply message;
receiving the anonymized reply message from the LLM, wherein the anonymized reply message comprises the unique identifier for the user without including the name of the user, the reply message further comprising the reply content that is responsive to the content of the message; and
replacing the unique identifier for the user with the name of the user in the anonymized reply message to generate a reply message, wherein the reply message includes the name of the user and does not include the unique identifier, wherein the name of the user is retrieved by a query that includes the unique identifier that is applied to the mapping; and
posting the reply message comprising the reply content and the name of the user in a thread containing the message.

2. The method of claim 1, wherein the unique identifier is a first unique identifier, where the method further comprises:
determining that a predetermined time period has lapsed from a time of the generation of the first unique identifier; and
in response to determining that the predetermined time period has lapsed from the time of the generation of the first unique identifier, generating a second unique identifier for the user, wherein the data structure associates the second unique identifier with the name of the user, where the second unique identifier is stored concurrently with the unique identifier, wherein the name of the user is retrieved using a query comprising either the first unique identifier and second unique identifier, wherein the name is replaced with the second unique identifier for messages that are received after the generation of the second unique identifier.

3. The method of claim 2, wherein the method further comprises: deleting the first unique identifier and second unique identifier in response to detecting that the thread is deleted or deactivated.

4. The method of claim 1, wherein the unique identifier is a first unique identifier, where the method further comprises:
determining that a time period has lapsed, wherein the time period is an event-initiated window of time that is initiated in response to the detection of an event; and
in response to determining that the predetermined time period has lapsed from the time of the generation of the first unique identifier, generating a second unique identifier for the user, wherein the data structure associates the second unique identifier with the name of the user, where the second unique identifier is stored concurrently with the unique identifier, wherein the name of the user is retrieved using a query comprising either the first unique identifier and second unique identifier, wherein the name is replaced with the second unique identifier for messages that are received after the generation of the second unique identifier, wherein the first unique identifier and the second unique identifier are deleted when the thread is deleted or deactivated.

5. The method of claim 1, wherein the message is a first message, wherein the unique identifier is a first unique identifier, wherein the thread is a first thread for a first group of users, wherein the method further comprises:
determining that a second message that references the name is received in a second thread for a second group of users, wherein the first group of users and the second group of users have different users; and
in response to determining that the second message that references the name is received in the second thread for the second group of users, generating a second unique identifier for the user, wherein the data structure associates the second unique identifier with the name of the user, where the second unique identifier is stored concurrently with the unique identifier, wherein the name of the user is retrieved using a query comprising either the first unique identifier and second unique identifier, wherein the name is replaced with the second unique identifier for messages that are received after the generation of the second unique identifier, wherein the first unique identifier is deleted when the first thread is deleted or deactivated, wherein the second unique identifier is deleted when the second thread is deleted or deactivated.

6. The method of claim 1, wherein the instructions for preserving the syntax of the name of the user and the unique identifier includes instructions that
cause the LLM to determine a portion of the message that meets criteria of having a predetermined format of the name in the message, and
cause the LLM to generate the reply message using the predetermined format of the name.

7. The method of claim 1, wherein the instructions further comprise examples using one or more predetermined formats of the name, the instructions further comprising valid response messages and invalid response messages defining constraints of the reply message.

8. A computing system for preserving privacy for users that are identified in messages that are used as an input for an agent generating reply messages, the computing system comprising:
one or more processing units; and
a computer-readable storage medium having encoded thereon computer-executable instructions to cause the one or more processing units to:
remove a name of a user from a message having content prior to sending the message to a large language model;
replace the name of the user in the message with a unique identifier for the user to generate an anonymized message that includes the unique identifier and the content of the message without the name of the user;
updating a data structure defining a mapping between names of users and unique identifiers generated for each user, wherein the data structure associates the name of the user and the unique identifier for the user for enabling the system to recall the name of the user based on the unique identifier;
generate a prompt for the LLM, the prompt including the
anonymized message that includes the unique identifier for the user without including the name of the user, the prompt further comprising
instructions for causing the LLM to generate an anonymized reply message based on the content of the anonymized message, the instructions further causing the LLM to preserve a syntax of the name of the user and the unique identifier and to include the unique identifier in the anonymized reply message;
communicate the prompt to the LLM for causing the LLM to generate the anonymized reply message according to the instructions using the content of the anonymized message that includes the unique identifier of the user without including the name of the user, the instructions further causing the LLM to generate reply content that is responsive to the content of the message, the instructions further causing the LLM to preserve the syntax of the name of the user and the unique identifier and to include the unique identifier in the anonymized reply message;
receiving the anonymized reply message from the LLM, wherein the anonymized reply message comprises the unique identifier for the user without including the name of the user, the reply message further comprising the reply content that is responsive to the content of the message; and
replacing the unique identifier for the user with the name of the user in the anonymized reply message to generate a reply message, wherein the name of the user is retrieved by a query that includes the unique identifier that is applied to the mapping; and
posting the reply message comprising the reply content and the name of the user in a thread containing the message.

9. The computing system of claim 8, wherein the unique identifier is a first unique identifier, wherein the computer-executable instructions further cause the one or more processing units to:
determine that a predetermined time period has lapsed from a time of the generation of the first unique identifier; and
in response to determining that the predetermined time period has lapsed from the time of the generation of the first unique identifier, generate a second unique identifier for the user, wherein the data structure associates the second unique identifier with the name of the user, where the second unique identifier is stored concurrently with the unique identifier, wherein the name of the user is retrieved using a query comprising either the first unique identifier and second unique identifier, wherein the name is replaced with the second unique identifier for messages that are received after the generation of the second unique identifier.

10. The computing system of claim 8, wherein the computer-executable instructions further cause the one or more processing units to: delete the first unique identifier and second unique identifier in response to detecting that the thread is deleted or deactivated.

11. The computing system of claim 8, wherein the unique identifier is a first unique identifier, wherein the computer-executable instructions further cause the one or more processing units to:
determine that a time period has lapsed, wherein the time period is an event-initiated window of time that is initiated in response to the detection of an event; and
in response to determining that the predetermined time period has lapsed from the time of the generation of the first unique identifier, generate a second unique identifier for the user, wherein the data structure associates the second unique identifier with the name of the user, where the second unique identifier is stored concurrently with the unique identifier, wherein the name of the user is retrieved using a query comprising either the first unique identifier and second unique identifier, wherein the name is replaced with the second unique identifier for messages that are received after the generation of the second unique identifier, wherein the first unique identifier and the second unique identifier are deleted when the thread is deleted or deactivated.

12. The computing system of claim 8, wherein the message is a first message, wherein the unique identifier is a first unique identifier, wherein the thread is a first thread for a first group of users, wherein the computer-executable instructions further cause the one or more processing units to:
determine that a second message that references the name is received in a second thread for a second group of users, wherein the first group of users and the second group of users have different users; and
in response to determining that the second message that references the name is received in the second thread for the second group of users, generate a second unique identifier for the user, wherein the data structure associates the second unique identifier with the name of the user, where the second unique identifier is stored concurrently with the unique identifier, wherein the name of the user is retrieved using a query comprising either the first unique identifier and second unique identifier, wherein the name is replaced with the second unique identifier for messages that are received after the generation of the second unique identifier, wherein the first unique identifier is deleted when the first thread is deleted or deactivated, wherein the second unique identifier is deleted when the second thread is deleted or deactivated.

13. The computing system of claim 8, wherein the instructions for preserving the syntax of the name of the user and the unique identifier includes instructions that
cause the LLM to determine a portion of the message that meets criteria of having a predetermined format of the name in the message, and
cause the LLM to generate the reply message using the predetermined format of the name.

14. The computing system of claim 8, wherein the instructions further comprise examples using one or more predetermined formats of the name, the instructions further comprising valid response messages and invalid response messages defining constraints of the reply message.

15. A computer-readable storage medium having encoded thereon computer-executable instructions for preserving privacy and security for users that are identified in messages that are used as an input for an agent generating reply messages, the computer-executable instructions configured to cause one or more processing units of a computing system to:
remove a name of a user from a message having content prior to sending the message to a large language model;
replace the name of the user in the message with a unique identifier for the user to generate an anonymized message that includes the unique identifier and the content of the message without the name of the user;
updating a data structure defining a mapping between names of users and unique identifiers generated for each user, wherein the data structure associates the name of the user and the unique identifier for the user for enabling the system to recall the name of the user based on the unique identifier;
generate a prompt for the LLM, the prompt including the
anonymized message that includes the unique identifier for the user without including the name of the user, the prompt further comprising instructions for causing the LLM to generate an anonymized reply message based on the content of the anonymized message, the instructions further causing the LLM to preserve a syntax of the name of the user and the unique identifier and to include the unique identifier in the anonymized reply message;
communicate the prompt to the LLM for causing the LLM to generate the anonymized reply message according to the instructions using the content of the anonymized message that includes the unique identifier of the user without including the name of the user, the instructions further causing the LLM to generate reply content that is responsive to the content of the message, the instructions further causing the LLM to preserve the syntax of the name of the user and the unique identifier and to include the unique identifier in the anonymized reply message;
receiving the anonymized reply message from the LLM, wherein the anonymized reply message comprises the unique identifier for the user without including the name of the user, the reply message further comprising the reply content that is responsive to the content of the message; and
replacing the unique identifier for the user with the name of the user in the anonymized reply message to generate a reply message, wherein the name of the user is retrieved by a query that includes the unique identifier that is applied to the mapping; and
posting the reply message comprising the reply content and the name of the user in a thread containing the message.

16. The computer-readable storage medium of claim 15, wherein the unique identifier is a first unique identifier, wherein the computer-executable instructions further cause the one or more processing units to:
determine that a predetermined time period has lapsed from a time of the generation of the first unique identifier; and
in response to determining that the predetermined time period has lapsed from the time of the generation of the first unique identifier, generate a second unique identifier for the user, wherein the data structure associates the second unique identifier with the name of the user, where the second unique identifier is stored concurrently with the unique identifier, wherein the name of the user is retrieved using a query comprising either the first unique identifier and second unique identifier, wherein the name is replaced with the second unique identifier for messages that are received after the generation of the second unique identifier.

17. The computer-readable storage medium of claim 15, wherein the computer-executable instructions further cause the one or more processing units to: delete the first unique identifier and second unique identifier in response to detecting that the thread is deleted or deactivated.

18. The computer-readable storage medium of claim 15, wherein the unique identifier is a first unique identifier, wherein the computer-executable instructions further cause the one or more processing units to:
determine that a time period has lapsed, wherein the time period is an event-initiated window of time that is initiated in response to the detection of an event; and
in response to determining that the predetermined time period has lapsed from the time of the generation of the first unique identifier, generate a second unique identifier for the user, wherein the data structure associates the second unique identifier with the name of the user, where the second unique identifier is stored concurrently with the unique identifier, wherein the name of the user is retrieved using a query comprising either the first unique identifier and second unique identifier, wherein the name is replaced with the second unique identifier for messages that are received after the generation of the second unique identifier, wherein the first unique identifier and the second unique identifier are deleted when the thread is deleted or deactivated.

19. The computer-readable storage medium of claim 15, wherein the message is a first message, wherein the unique identifier is a first unique identifier, wherein the thread is a first thread for a first group of users, wherein the computer-executable instructions further cause the one or more processing units to:
determine that a second message that references the name is received in a second thread for a second group of users, wherein the first group of users and the second group of users have different users; and
in response to determining that the second message that references the name is received in the second thread for the second group of users, generate a second unique identifier for the user, wherein the data structure associates the second unique identifier with the name of the user, where the second unique identifier is stored concurrently with the unique identifier, wherein the name of the user is retrieved using a query comprising either the first unique identifier and second unique identifier, wherein the name is replaced with the second unique identifier for messages that are received after the generation of the second unique identifier, wherein the first unique identifier is deleted when the first thread is deleted or deactivated, wherein the second unique identifier is deleted when the second thread is deleted or deactivated.

20. The computer-readable storage medium of claim 15, wherein the instructions for preserving the syntax of the name of the user and the unique identifier includes instructions that
cause the LLM to determine a portion of the message that meets criteria of having a predetermined format of the name in the message, and
cause the LLM to generate the reply message using the predetermined format of the name.
